(19) United States
(12) Patent Application Publication
(10) Pub. No.: US 2004/0089099 A1
(43) Pub. Date: May 13, 2004

(54) Wrist pin

(75) Inventors: Randall R. Gaiser, Chelsea, MI (US); Carmo Ribeiro, Ann Arbor, MI (US)

Correspondence Address: Robert L. Stearns, 5291 Colony Drive North, Saginaw, MI, 48603, US

(73) Assignee: Federal-Mogul World Wide, Inc.

(21) Appl. No.: 10/293,844

(22) Filed: Nov. 13, 2002

(51) Int. Cl. F16C 3/04

(52) U.S. Cl. 74/595

(57) ABSTRACT

A wrist pin is provided comprising a generally cylindrical body having a longitudinal axis. The body is fabricated of at least two metallic parts joined to one another at a weld joint. In joining the two parts to one another, a pair of laterally spaced support ribs are defined and an internal chamber is further defined between the support ribs.

### BACKGROUND OF THE INVENTION

1. Technical Field

The invention relates generally to wrist pins used for coupling pistons to connecting rods.

2. Related Art

Internal combustion engines typically have wrist pins coupling pistons to connecting rods. Wrist pins are subjected to relatively heavy loading stemming from reciprocation of the pistons within their respective cylinder bores and from vacuum forces within a crankcase. The reciprocating movement of the pistons within the cylinder bores generates opposing axial forces acting on the wrist pins, thus causing the wrist pins to deflect relative to their longitudinal axes. Continual efforts are made in design and manufacture of wrist pins to reduce the potential for deflection of the wrist pins, as such deflection is undesirable.

Wrist pins are typically formed from a single piece of material and as either a solid member or a generally tubular member. Solid wrist pins provide inherent benefits in minimizing the potential deflection to the wrist pins in use, while the tubular style wrist pins provide the inherent benefit of reduced weight. Conversely, solid wrist pins carry an increased weight, while tubular wrist pins are typically more prone to deflection. As such, there are tradeoffs between the advantages and disadvantages in the current state of art in designing and manufacturing wrist pins. Ultimately, it would be advantageous to have wrist pins that are both lightweight in construction, as provided by the current tubular constructions, and that are resistant to deflection, as currently provided by the solid construction.

### SUMMARY OF THE INVENTION

A wrist pin constructed according to the invention includes a generally cylindrical body having a longitudinal axis. The body is fabricated of at least two metallic parts joined at a weld joint and defining a pair of laterally spaced support ribs separated by an internal chamber.

One advantage of the present invention is that it provides a wrist pin that is both strong and lightweight.

Another advantage of the present invention is that such a wrist pin is resistant to deflection under load.

Another advantage of the present invention is that the construction provides improved heat dissipation over solid wrist pins.

Another advantage of the present invention is that such a wrist pin can be made by a simple, economic method.

### BRIEF DESCRIPTION OF THE DRAWINGS

These and other features and advantages of the present invention will become more readily appreciated when considered in connection with the following detailed description and appended drawings, wherein:

FIG. 1 is an isometric view of a wrist pin constructed according to a presently preferred embodiment of the present invention;

FIG. 2 is a cross sectional view taken generally along line 2-2 of FIG. 1; and

FIG. 3 is a view similar to FIG. 2 showing a presently preferred alternate embodiment of the present invention.

### DETAILED DESCRIPTION OF THE

### PREFERRED EMBODIMENTS

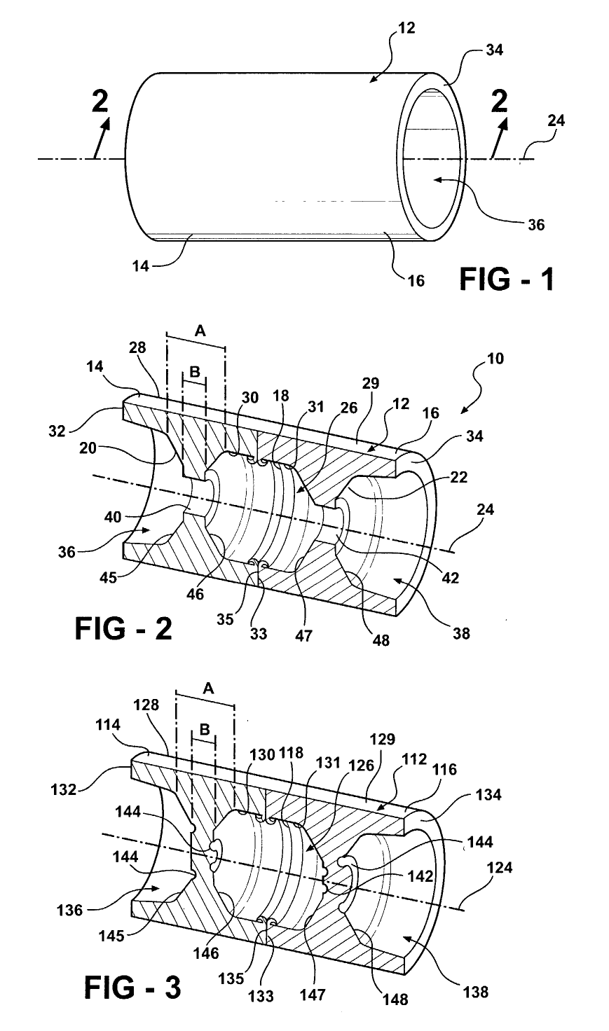

A wrist pin constructed according to a presently preferred embodiment of the invention is shown generally at 10 in FIGS. 1 and 2. The wrist pin 10 has a generally cylindrical body 12 fabricated of at least two metallic portions or parts 14, 16 joined to one another at a weld joint 18 to form a single part. Each metallic part 14, 16 has at least one support rib 20, 22, respectively, such that when the two metallic parts 14, 16 are joined, the support ribs 20, 22 are laterally spaced from one another relative to a longitudinal axis 24. In joining the two metallic parts 14, 16 to one another, an internal chamber 26 is defined between the support ribs 20, 22. The internal chamber 26 provides the wrist pin 10 with a reduced weight, while the support ribs 20, 22 provide the wrist pin 10 with strength to reduce the potential for deflection of the wrist pin 10 in use.

Preferably, as best shown in FIG. 2, the metallic parts 14, 16 forming the body 12 are a pair of generally symmetrical parts. Each part 14, 16 has an outer surface 28, 29, respectively, and an inner surface 30, 31, respectively. The parts 14, 16 terminate at opposite ends 32, 33 and 34, 35, respectively. The support rib 20 is constructed between the ends 32, 33 of the part 14, and the support rib 22 is formed between the ends 34, 35 of the part 16.

The ends 33, 35 of the parts 14, 16 are preferably formed to facilitate welding the two ends 33, 35 together. The two parts 14, 16 are preferably friction welded together, though other welding techniques may be used. As a result of friction welding the two parts 14, 16 together, the weld joint 18 is formed and exposed to the chamber 26.

The internal chamber 26 defines a hollowed portion within the wrist pin 10 between the support ribs 20, 22. In addition, since the support ribs 20, 22 are inset from the ends 32, 34, a pair of end recesses or hollowed portions 36, 38 are formed adjacent the ends 32, 34 of the respective parts 14, 16 which terminate at the respective support ribs 20, 22. The hollowed portions 26, 36, 38 serve to reduce the weight of the finished wrist pin 10, while the support ribs 20, 22 serve as pillars to provide needed structural integrity to the wrist pin.

As best shown in FIG. 2, at least one opening 40, 42 is preferably formed in each support rib 20, 22, respectively. The openings 40, 42 lend to further weight reduction of the wrist pin 10, and also provides an open passage into the chamber 26 for air and oil flow, and thus cooling of the wrist pin 10.

FIG. 3 shows an alternative embodiment in which pockets, grooves, or recess 44 are formed in the opposite sides 45, 46 of the support rib 20 and/or in the opposite sides 47, 48 of the support rib 22 to remove material and thus weight from the ribs 20, 22 without affecting their structural integrity. The same reference numerals are used to represent like features in the first embodiment of FIGS. 1 and 2, but are offset by 100. The invention contemplates that the openings 40, 42 may be used in conjunction with the recesses 44, and that many different formations of openings or recesses may be employed other than those illustrated in the drawings.

Turning again to the first embodiment of FIGS. 1 and 2, to facilitate uniform load distribution throughout the wrist pin 10, the opposite sides 45, 46 of the support rib 20 and the sides 47, 48 of the support rib 22 are preferably tapered to blend smoothly with the inner surfaces 30, 31, respectively. The opposite sides 45, 46 and 47, 48 taper axially toward each other as they extend radially inwardly from their respective inner surfaces 30, 31. A first thickness, represented as A, is defined adjacent each inner surface 30, 31, and a second thickness, represented as B, is defined radially inwardly from the first thickness A. The first thickness A is preferably formed thicker than the second thickness B to create the blending of the support ribs 20, 22 with the inner surfaces 30, 31. This construction helps to eliminate any stress risers that otherwise may result from having sharp edges between the support ribs 20, 22 and the inner surfaces 30, 31. The ribs 20, 22 also provide for more uniform loading throughout the wrist pin 10, thereby providing a wrist pin capable of withstanding the severe loading encountered in a wrist pin application. As such, the wrist pin 10 is provided having a generally lightweight construction, facilitated by the internal chamber 26 and the hollowed portions 36, 38, while also having a rigid construction, facilitated by the support ribs 20, 22 that resists deflection in use.

It should be recognized that though presently preferred constructions are shown in the drawings, other constructions having different support rib constructions along with various opening or recess constructions can be provided within the scope of the invention.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A wrist pin, comprising:
a generally cylindrical body having a longitudinal axis fabricated of at least two metallic parts joined to one another at a weld joint and defining a pair of laterally spaced support ribs and an internal chamber between said support ribs.

2. The wrist pin of claim 1 wherein said at least two metallic parts are generally symmetrical to one another.

3. The wrist pin of claim 1 wherein said generally cylindrical body has a pair of opposite ends and said pair of support ribs are arranged between said opposite ends.

4. The wrist pin of claim 1 wherein each of said at least two metallic parts has opposite ends and a separate one of said pair of support ribs is formed between said opposite ends of a separate one of said at least two metallic parts.

5. The wrist pin of claim 1 wherein said pair of support ribs each have an opening extending therethrough.

6. The wrist pin of claim 1 wherein said pair of support ribs each have opposite sides with at least one recess formed in at least one of said opposite sides.

7. The wrist pin of claim 1 wherein said weld joint is formed as a friction weld.

8. The wrist pin of claim 7 wherein said friction weld forms a bead extending radially inwardly toward said longitudinal axis.

9. The wrist pin of claim 1 wherein said generally cylindrical body has an inner surface with each of said pair of support ribs having opposite sides that taper axially toward each other as said opposite sides extend radially inwardly from said inner surface defining a first thickness adjacent said inner surface and a second thickness radially inwardly from said first thickness wherein said first thickness is thicker than said second thickness.

10. A method of fabricating a wrist pin, comprising:
fabricating a first wrist pin portion;
fabricating a second wrist pin portion separately from the first wrist pin portion; and
joining the portions together across a weld joint to define a pair of axially spaced support ribs and an internal chamber between said support ribs.

11. The method of claim 10 wherein the portions are jointed by friction welding.

12. The method of claim 10 wherein the weld joint extends into the chamber.

13. The method of claim 12 wherein the weld joint is located between and axially spaced from the support ribs.

14. The method of claim 10 including providing a passage through at least one of said support ribs into said chamber.

15. The method of claim 14 including providing a passage through both support ribs.

16. The method of claim 10 including spacing the support ribs axially inwardly from axially opposite ends of the wrist pin to form end recesses in the wrist pin.
